(19) United States
(12) Patent Application Publication
(10) Pub. No.: US 2012/0017399 A1
(43) Pub. Date: Jan. 26, 2012

(54) SAFETY CURTAIN STRUCTURE

(76) Inventor: Hsien-Te HUANG, Taipei City (TW)

(21) Appl. No.: 13/179,891

(22) Filed: Jul. 11, 2011

(30) Foreign Application Priority Data
Jul. 20, 2010 (TW) 099123746

(51) Int. Cl. F16G 11/10

(52) U.S. Cl. 24/115 F

(57) ABSTRACT

In a safety curtain structure, an assembly of a pulling string and a curtain brake mechanism can be separated easily when a force is applied onto the curtain pulling string by accident, such that a binding force of the pulling string can be released quickly to assure the safety for protecting children's limbs at a certain height, and allowing the pulling string to fully apply a force to a brake mechanism to satisfy the requirement of moving or stopping a reasonable load when a curtain is rolled normally.

### BACKGROUND OF THE INVENTION

a) Field of the Invention

The present invention relates to a safety curtain structure of operating the system, and more particularly to a safety curtain structure for immediately separating a pulling string from a curtain brake mechanism when a force is applied to the pulling string of the curtain by accident, such that the pulling string can be released quickly to achieve the safety effect of preventing a child's limbs from being wound by the pulling string accidentally, and a force can be applied fully to the pulling string and transmitted to a brake mechanism to provide the required force for rolling the curtain under a normal operation, and the main body of the present invention is a universal coupling brake mechanism, comprising a hub with an internal span formed at the bottom of the hub for expanding and contracting a cartridge and provided for embedding and combining a moving/braking unit, and a universal driving shaft capable of driving a chain of the moving/braking unit to transmit the hub to indirectly adjust a light shading area of the curtain. Under the normal operation of a snap-in frame, a secured latching, locking and combining relation can be achieved, such that a force can be applied fully to a pulling string to meet the requirement of transmitting a brake force to the universal driving shaft to turn towards the hub, such that if a child plays with the pulling string and the pulling string winds around the child's limb accidentally, just a small portion of the binding force transmitted to the snap-in frame in a reverse direction can change position of the snap-in frame to separate from the cartridge, and the fixing force at the top of the chain will disappear, and the binding force at the bottom of the chain that winds the child's limb will be released quickly.

b) Description of the Related Art

An opening of a window is provided for allowing or blocking a portion or all of the light projected into a house, and a curtain is provided for shading the light, and the level of light shading of the curtain can be adjusted according to a user's requirement. A common way of making such adjustment is to operate a pulling string manually, and the pulling string is generally loop-shaped to satisfy the requirement for a higher path of the curtain, and the top of the pulling string is fixed to a brake mechanism installed at a universal connecting position of a rod of the curtain, and a drooping end becomes a close loop end, and the drooping end is provided for facilitating a user's hands to operate the pulling string, and the bottom of the pulling string is usually drooped to a height above the floor and approximately to the waist of the user, and a child can play with the pulling string at such height easily, and thus the pulling string is a potential risk to children who may be wound by the pulling string accidentally.

With reference to FIGS. 1 and 2 for a conventional curtain pulling string, a brake mechanism 101 is connected to a curtain module 100 through the fixed frame 103 on both sides of the curtain module 100 and provided for driving a rolling cylinder 106, wherein the brake mechanism 101 includes a moving/braking wheel 104 moved or stopped by a pulling string 102, and a kinetic force produced by the pulling string 102 is transmitted to a driving shaft 105 to drive and roll a rolling cylinder 106 to change the sun shading area of the curtain, and the curtain module 100 is mounted onto a wall, and the brake mechanism 101 can be pulled by the pulling string 102, and the pulling string 102 is also fixed onto the wall, and a lower drooping end of the pulling string 102 is a close looped end, and thus there is a risk of winding a child's limb 107 accidentally when the child plays with the pulling string.

To maintain safety, R.O.C. Pat. No. M32278 provides a safety fixing device of a curtain pulling string, wherein an upper end of the fixing device is combined with both ends of a close-loop pulling string, and a lower end of the fixing device is connected to a pulling string to eliminate the close-loop end; and R.O.C. Pat. No. M266007 provides a pulling string positioning structure, wherein a fixed base is combined with a wall to limit the position of a free end at the bottom of the pulling string, so as to prevent children from playing with the pulling string; and R.O.C. Pat. No. M253301 adopts a magnetic attracting separator installed at a break position of the pulling string, such that the pulling string will be magnetically detached to achieve an effective safety effect when a child is playing with the pulling string and the child's limb is wound by the pulling string in the situation of applying a force improperly; and R.O.C. Pat. No. M245915 provides a safety pulling string separating device having an elastic tapered neck section formed at the bottom of sheathing portion of the pulling string, and the tapered neck section is provided for sheathing a sheathing element, and the sheathing element can be elastically separated from a fixing portion, such that a section of the pulling string will be detached in the case of applying a force improperly. In addition, many designs and methods related to the safety protection of a puling string can be found in IPC A47H-003/04, but none of them can meet the requirement for the loop-shaped pulling string.

The pulling string can be moved continuously in cycles to meet the requirement of adjusting the height of the curtain, and the pulling string driven by a moving/braking wheel can ascend or descend the curtain, and the brake wheel comes with a structure with a small diameter, such that the pulling string can be moved linearly with a very limited distance due to the rotational speed of the wheel, unless there is sufficient space for installing an additional speed change device. For example, a loop-shaped pulling string is pulled a round, the rotational speed ratio of the wheel is 1:10, and ten rounds of rotation can move the curtain to a displacement of one meter only. If the height of the opening of the window is 2 m, then it is necessary for user to pull the pulling string two rounds to satisfy the 2 m requirement, and thus the pulling string must be able to loop continuous without any hindrance. In the design of the aforementioned patents M253301 and M245951, the loop-shaped pulling string is connected to other components with a detachable break, which will restrict the loop movement of the pulling string to one round only, and cannot satisfy the requirement of adjusting the height of a large curtain.

### SUMMARY OF THE INVENTION

Therefore, it is a primary objective of the invention to provide a safety curtain structure, such that if a pulling string of a curtain is wound around a child's limb by accident, the pulling string will be separated from a brake mechanism immediately to release the binding force of the pulling string, so as to achieve the desired safety effect, and in normal operation, the angle of latching the snap-in frame can be changed to achieve a secured connection, such that the pulling string can transmit a braking force for a reasonable load to meet the requirement of adjusting the light shading area of the curtain.

A second objective of the present invention is to provide a method that forms a pivot hole and two symmetrical conjugated first and second kidney-shaped holes on the cartridge and designs a pivot ring with an evacuated movable plane to the snap-in frame, such that after the two symmetrical first and second stop pegs are combined, and a child's limb is wound by the pulling string accidentally, pulldown forces are produced on both sides of the pulling string simultaneously and indirectly acted onto one of the stop pegs to form a fulcrum, and the distance between the fulcrum and a circular tangent position on another side of the moving/braking wheel is the length of the lever that can produce a much better lever effect and increase the squeezing force, so that the pivot ring can overcome the coupling force of the cartridge to expand the internal span and drive the snap-in frame of the pulling string to be separated from the cartridge easily, so as to achieve the quick-release safety effect.

A third objective of the present invention is to pivotally connect the moving/braking wheel into the pivot hole of the snap-in frame through a wheel axle, such that after the moving/braking wheel is braked by a chain, indirect moving frictional forces of the moving/braking wheel and the snap-in frame synchronously rotate the snap-in frame at an initial time, such that the pivot ring and the first and second stop pegs of the snap-in frame can produce a change of angular position to obtain at least one latch point, and the latch point is provided for maintaining the connection of the snap-in frame and the cartridge to allow users to apply a force fully and freely at a side of the chain.

A four objective of the present invention is to provide a snap-in frame formed by two opposite flat plates and a connecting plate connected laterally and separately to the flat plates, and the interior of the snap-in frame is provided for pivotally installing a moving/braking wheel, and a through opening is formed between an external surface of the moving/braking wheel and the connecting plate and provided for passing a chain and providing a blocking effect, such that a movable connection between the snap-in frame and the chain can be achieved normally, and such arrangement can prevent small snap-in frame from falling out, missing, or eaten by children accidently after the snap-in frame is separated from the cartridge.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a schematic view of an overall assembly with a loop-shaped pulling string in accordance with the prior art;

FIG. 2 is a schematic view showing a limb wound by a lower end of a curtain pulling string in accordance with the prior art;

FIG. 3 is a perspective view of a moving/braking unit and a cartridge in accordance with the present invention before the moving/braking unit and cartridge are combined;

FIG. 4 is a side view of an assembly of a moving/braking unit and a cartridge in accordance with the present invention after the moving/braking unit and cartridge are combined;

FIG. 5 is a schematic view showing the related position of an assembled curtain in accordance with the present invention;

FIG. 6 is a cross-sectional view of Section A-A′ of FIG. 5;

FIG. 7 is a schematic view of a snap-in frame in accordance with the present invention;

FIG. 8 is a side view of a snap-in frame and a cartridge in accordance with the present after the snap-in frame and cartridge are combined;

FIG. 9 is a schematic view showing the pre-operation of assembling a snap-in frame to a cartridge in accordance with the present invention;

FIG. 10 is a schematic view showing the process of pressing a cartridge into a snap-in frame in accordance with the present invention;

FIG. 11 is a schematic view showing the normal opposite positions of a snap-in frame and a cartridge in accordance with the present invention after the snap-in frame and cartridge are combined;

FIG. 12 is a schematic view showing an angular change of a snap-in frame after a chain is stopped in one direction in accordance with the present invention;

FIG. 13 is a schematic view showing an action produced when forces are synchronously applied to both sides of a chain in accordance with the present invention;

FIG. 14 is a schematic view showing the operation of squeezing a pivot ring of a snap-in frame with a pivot hole of a cartridge in accordance with the present invention;

FIG. 15 is a schematic view of a snap-in frame being squeezed through an internal span of a cartridge and about to be separated in accordance with the present invention;

FIG. 16 is a front view of a snap-in frame of the present invention before the snap-in frame is separated; and

FIG. 17 is a cross-sectional view of Section B-B′ as depicted in FIG. 16.

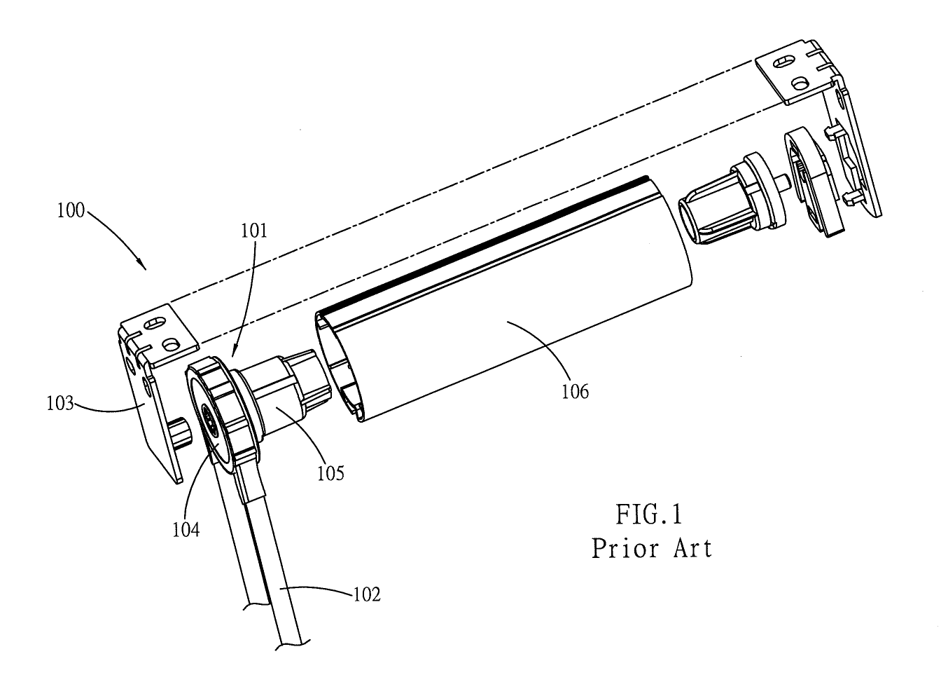

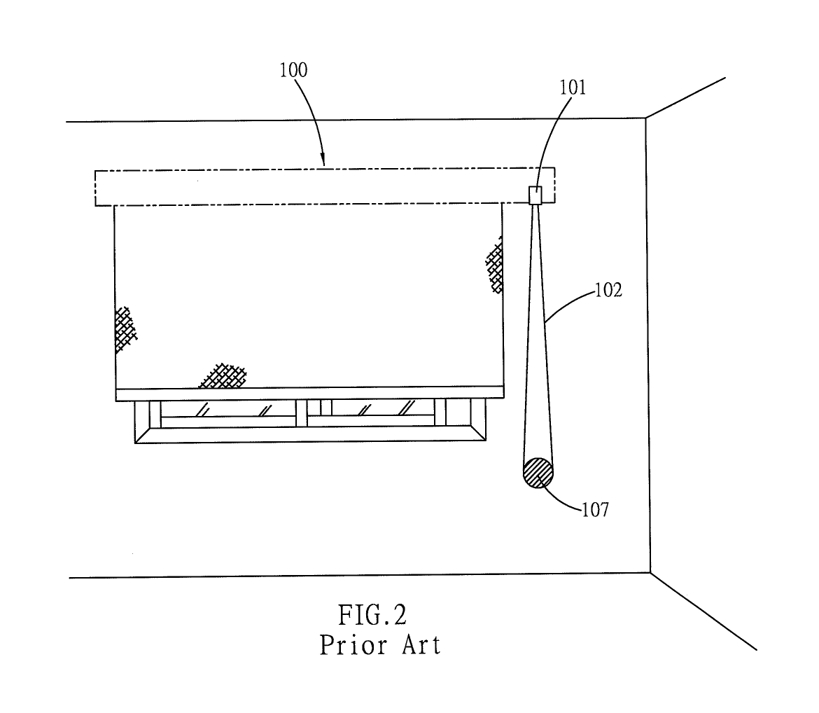

### DETAILED DESCRIPTION OF THE PREFERRED EMBODIMENTS

The technical characteristics and effects of the present invention will be apparent with the detailed description of preferred embodiment together with the illustration of related drawings as follows.

The present invention provides a safety curtain structure having a loop-shaped pulling string, such that when the curtain is operated in a normal condition, a force can be applied fully to the pulling string (or chain) for the operation, and the pulling string can be separated from a brake mechanism quickly during an emergency situation, so as to release the binding force of the pulling string and achieve the safety effect, wherein a fulcrum is used for increase the moment to reduce the force required for the separation, so as to detach the pulling string from the brake mechanism easily.

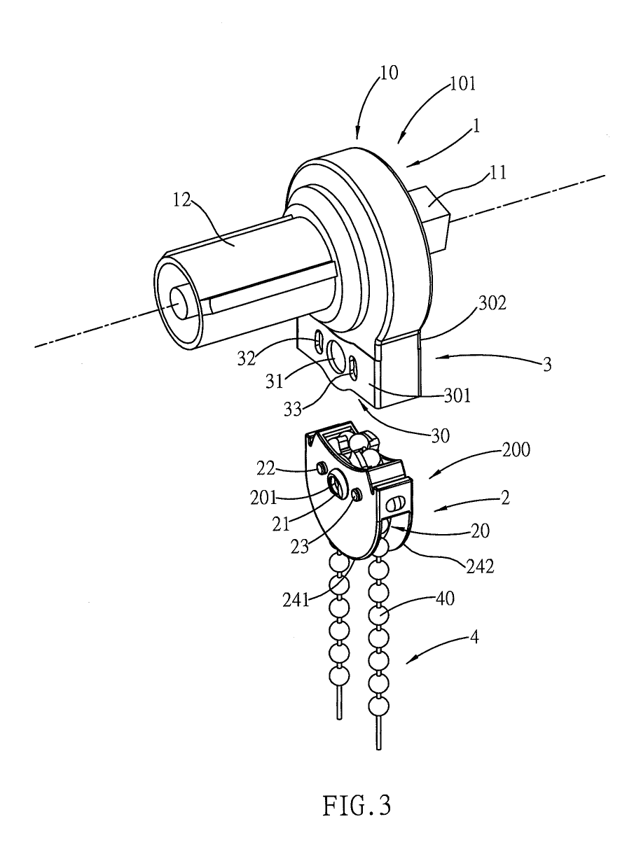

With reference to FIG. 3 for a moving/braking unit 200 of the present invention, the moving/braking unit 200 is comprised of a snap-in frame 2 and a chain 4 flexibly connected to the snap-in frame 2, wherein the snap-in frame 2 can enter or exit the cartridge 3. A safety curtain structure of the present invention comprises: a hub 1, a hanging portion 11 formed on an external surface of the hub 1 and provided for combining a rod (not shown in the figure) of a curtain; a driven wheel 10 pivotally installed in the hub 1; a universal driving shaft 12 extended outwardly along the axis of a axial center of the driven wheel 10 and used for rolling the curtain; a cartridge 3 coupled to a lower circular tangent position of the hub 1 and comprising a cartridge opening 30, a joint plate 301 and a joint plate 302, wherein planes of the joint plates 301 and 302 are perpendicular to the axial center of the universal driving shaft 12; a pivot hole 31 separately formed on the joint plates 301, 302, penetrated through the front and the back and disposed at a linear position parallel to the axis of the axial center, and a first kidney-shaped hole 32 and a second kidney-shaped hole 33 being symmetrical conjugated and disposed on both sides of the center of the pivot hole 31, wherein the cartridge opening 30 is interconnected to the interior of the hub 1 through the internal space of the cartridge 3.

The moving/braking unit 200 is comprised of a snap-in frame 2 that can enter and exit the cartridge opening 30 and a chain 4 flexibly coupled to the snap-in frame 2, wherein flat plates 241, 242 are disposed at positions of a plane of the snap-in frame 2 parallel to the joint plates 301, 302, and a pivot ring 21 protruded outwardly and disposed at the center of the flat plate 241, 242, and the pivot ring 21 can be movably assembled to the pivot hole 31, and a first stop peg 22 and a second stop peg 23 formed on both sides of the center of the pivot ring 21 and opposite to the first kidney-shaped hole 32 and the second kidney-shaped hole 33 respectively, and the pivot ring 21 of the snap-in frame 2 is provided for pivotally installing a moving/braking wheel 20 through a wheel axle 201, and a circular surface of the moving/braking wheel 20 is provided for chaining the chain 4, and the chain 4 includes a plurality of beads 40, and the moving/braking wheel 20 includes serrated grooves corresponding to the beads 40 to moving the chain 4 (wherein the moving/braking wheel 20 serves as a chain wheel having the serrated grooves to engage the beads).

The surface of the pivot ring 21 can be a plane or a camber capable of providing a squeeze action.

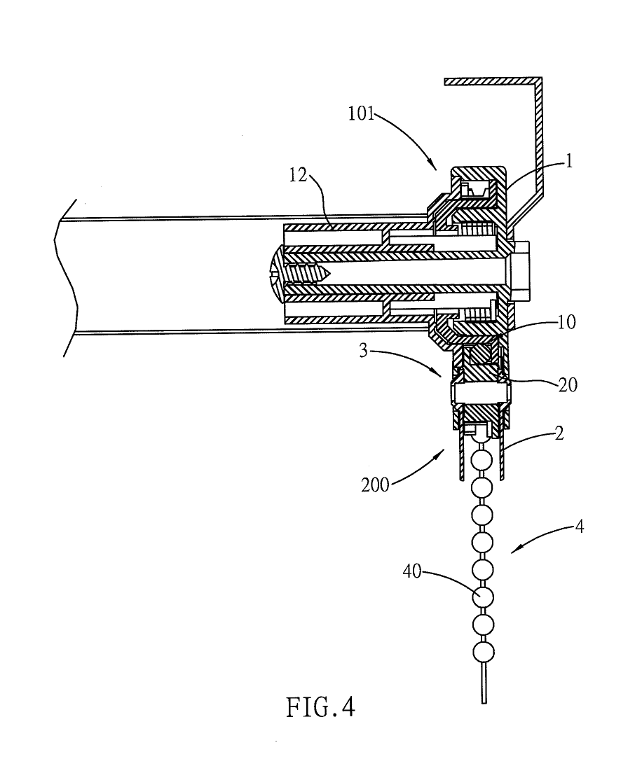

With reference to FIG. 4, a driven wheel 10 is pivotally installed in the hub 1, and the driven wheel 10 is engaged with the moving/braking wheel 20, and the moving/braking wheel 20 is linked by a plurality of beads 40 of the chain 4, such that the moving/braking wheel 20 can be driven to engage the driven wheel 10, and the kinetic energy obtained by the driven wheel 10 can be transmitted coaxially to the universal driving shaft 12, and such driving relation can achieve the transmission of a driving force after the moving/braking unit 200 is combined into the cartridge 3 and the external periphery of the moving/braking wheel 20 is tangentially engaged with the external periphery of the driven wheel 10.

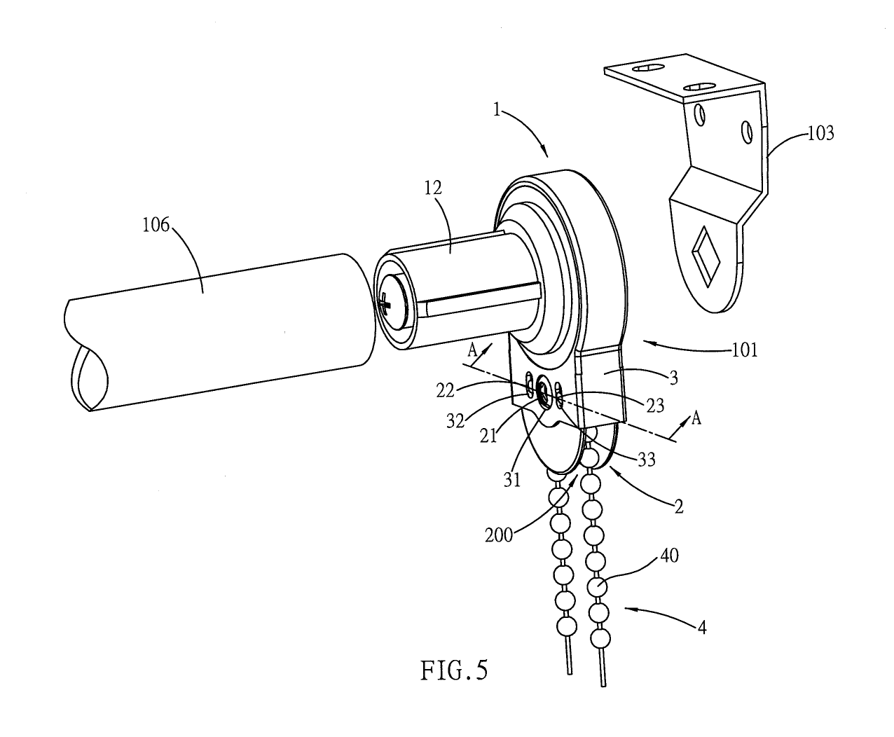

With reference to FIG. 5, a brake mechanism 101 of the present invention is assembled to a rod on the curtain through a fixed frame 103, and the universal driving shaft 12 is provided for rolling a curtain to adjusting the light shading condition of the curtain.

In the aforementioned assembly, the moving/braking unit 200 is embedded and combined into the cartridge 3, and the first stop peg 22 and second stop peg 23 are movably conjugated at the first kidney-shaped hole 32 and second kidney-shaped hole 33 of the cartridge 3, and the pivot ring 21 of the snap-in frame 2 is pivotally coupled into the pivot hole 31 of the cartridge 3, such that a user can operate the chain 4 to indirectly drive the universal driving shaft 12 of the hub 1 to provide a normal use of rolling and operating the curtain.

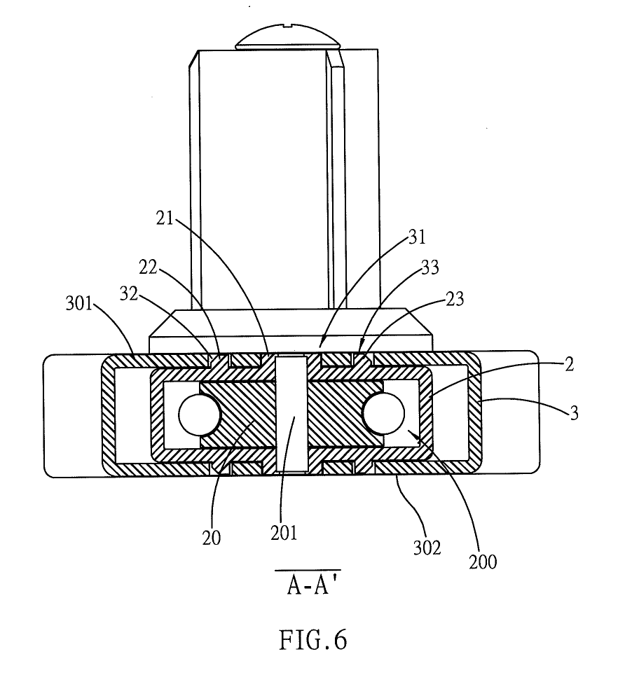

With reference to FIG. 6 for a across-sectional view of a cartridge 3 as depicted in FIG. 5, the moving/braking unit 200 provides a wheel axle 201 pivotally coupled to the moving/braking wheel 20 by the pivot ring 21 of the snap-in frame 2, and the pivot ring 21 is movably pivoted at the position of the pivot hole 31, and the first stop peg 22 and the second stop peg 23 on both sides are movably and respectively disposed at the first kidney-shaped hole 32 and the second kidney-shaped hole 33, and the moving/braking unit 200 can be combined into the cartridge 3 by using the height and squeeze force of the pivot ring 21 to elastically expand a span between the joint plate 301 and the joint plate 302. After the pivot ring 21 is elastically restored the pivot hole 31 will be sheathed on the external periphery of the pivot ring 21.

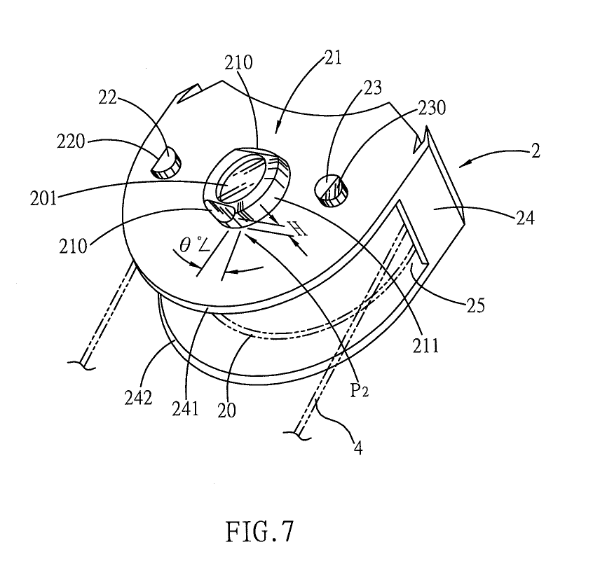

With reference to FIG. 7, the snap-in frame 2 of the present invention includes two flat plates 241, 242 disposed opposite to each other with respect to the center, and their laterals are connected by connecting plates 24, and symmetrical pivot rings 21 are penetrated through the center of a surface, and a first stop peg 22 and a second stop peg 23 are disposed on both sides with respect to the center of the pivot ring 21, and the center of the pivot ring 21 is provided for pivotally installing the moving/braking wheel 20, and a through opening 25 is formed between the external circumferential surface of the moving/braking wheel 20 and the internal surface of the connecting plate 24 and provided for passing the chain 4, such that the chain 4 can be blocked by the connecting plate 24, and the body of the chain 4 is always clamped by the snap-in frame 2. The chain 4 can be separated from the snap-in frame 2 only if the moving/braking wheel 20 is removed. In general, the chain 4 and the snap-in frame 2 are combined normally.

The connecting plate 24 further maintains a relative distance between the flat plate 241 and the flat plate 242, and the pivot ring 21 is a protruding circular body having a radial plane 211 perpendicular to the flat plate 241 or the flat plate 242, and an evacuated movable plane 210 slanted outwardly from a lower circular tangent position of the pivot ring 21, and the evacuated movable plane 210 is in a crescent shape having a height H and a radial plane 211 defined at a lateral of the evacuated movable plane 210 and on a surface proximate to the bottom of the flat plate 242, and the radial plane 211 has a latch point P₂, and the first stop peg 22 and the second stop peg 23 also have outwardly oblique slant diagonal plane 220 and diagonal plane 230 facing outward in a direction opposite to the center of the pivot ring 2.

The snap-in frame 2 is integrally formed by a plastic injection molding process, and the moving/braking wheel 20 is assembled by sheathing the external periphery of the moving/braking wheel 20 on the chain 4, and then aligning the center of the moving/braking wheel 20 with the pivot ring 21, and pivotally coupling the wheel axle 201 to complete the assembly, such that the moving/braking wheel 20 can be rotated freely with respect to the snap-in frame 2, and the moment of the rotation of the moving/braking wheel 20 will be transmitted to the snap-in frame 2 based on the friction.

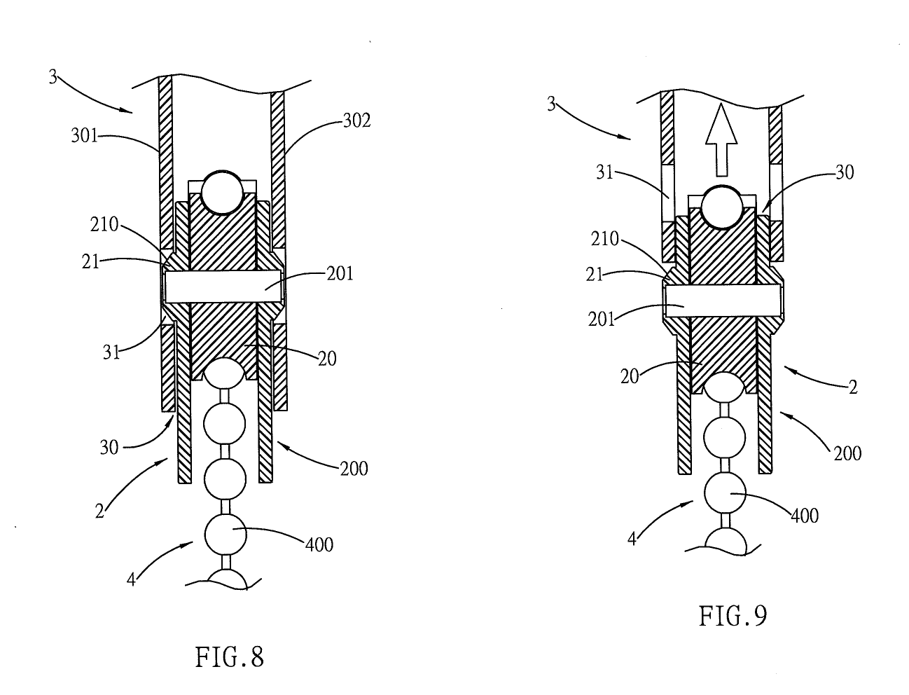

With reference to FIG. 8, the wheel axle 201 is pivotally installed at the position of an axial hole of the moving/braking wheel 20, and both sides of the wheel axle 201 are restricted by the pivot rings 21 of the snap-in frame 2 respectively, such that the wheel axle 201 will not be separated, and movable frictions are formed between the moving/braking wheel 20 and the wheel axle 201, and between the wheel axle 201 and the snap-in frame 2. Therefore, the moving/braking wheel 20 and the snap-in frame 2 are indirectly and movably coupled with each other, and the pivot ring 21 is pivotally installed into the pivot hole 31.

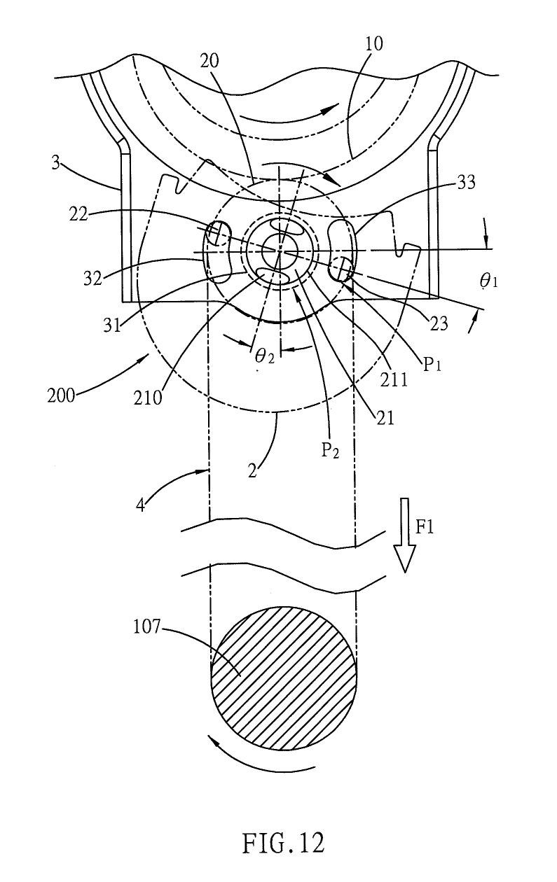

In the process of sheathing the moving/braking unit 200 of the present invention into the cartridge 3, any external operation can be used to expand the cartridge opening 30 of the cartridge 3 to receive the snap-in frame 2, or the evacuated movable plane 210 formed at a circular tangent point of the pivot ring 21 is used for squeezing and expanding the cartridge opening 30. In the figure, the evacuated movable plane 210 is an oblique plane and cannot be disposed pivotally across the internal circumferential surface of the pivot hole 31. Now, the evacuated movable plane 210 is in a static state, and the pivotal span creates a slight static combining force, and when the chain 4 is pulled, it will not fall off easily, but an angular change of the evacuated movable plane 210 of the pivot ring 21 will occur, such that the radial plane 211 of the pivot ring 21 as shown in FIG. 7 will be situated downwardly across the internal surface of the pivot hole 31, and the details will be described together with FIG. 12 later.

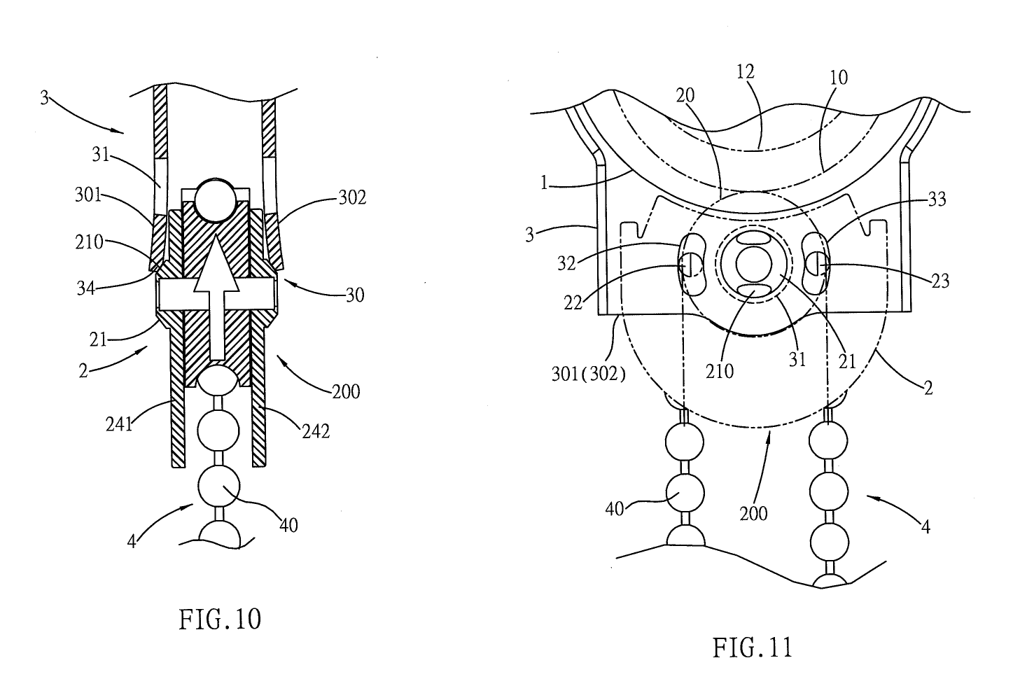

In the process of operating the moving/braking unit 200 combined with the cartridge 3 as shown in FIGS. 9 to 11, the length between both ends of the pivot ring 21 installed to the snap-in frame 2 of the moving/braking unit 200 is greater than the internal width of the cartridge opening 30 of the cartridge 3, and finally the pivot ring 21 is combined with the pivot hole 31 as shown in FIG. 8. Similarly, the assembling process adopt any external force to expand the cartridge opening 30, so that the present invention provides a squeeze action in an opposite direction, and another oblique evacuated movable plane 210 is formed at an upper circular curve tangent position of the pivot ring 21. At the beginning, when the evacuated movable plane 210 will be squeezed, a lower corner 34 of the cartridge opening 30 will also be squeezed, and the span between the joint plate 301 and the joint plate 302 will be elastically spread open, and finally a further squeeze moves the center of the pivot ring 21 precisely to the axial center of the pivot hole 31, and the elastic restoration of the joint plate 301 and joint plate 302 allows the pivot ring 21 to be pivotally disposed across the axial center of the pivot hole 31, and the restored condition is shown in FIG. 8.

With reference to FIG. 11 for the front view of the aforementioned assembly, the snap-in frame 2 of the moving/braking unit 200 is combined with the cartridge 3, and the pivot ring 21 installed on the snap-in frame 2 is coaxially and pivotally installed at the center of the pivot hole 31, and the first stop peg 22 and the second stop peg 23 of the snap-in frame 2 can be moved within the first kidney-shaped hole 32 and the second kidney-shaped hole 33 of the cartridge 3 with respect to the center of the pivot hole 31, and the scope of the moving angular position is restricted by the first kidney-shaped hole 32 and second kidney-shaped hole 33, and the assembled moving/braking wheel 20 of the moving/braking unit 200 is engaged with the driven wheel 10 of the hub 1, and after the chain 4 drives the moving/braking wheel 20, the driving force of the chain 4 will be transmitted to the driven wheel 10 to drive the universal driving shaft 12.

With reference to FIG. 12, users can pull the moving/braking wheel 20 through a side of the chain 4 at an initial time, and the friction produced can rotate the snap-in frame 2 clockwise, and the angular change of the snap-in frame 2 drives the first stop peg 22 and the second stop peg 23 to change their position to an angle θ₁, and the change of angular positions of the first stop peg 22 and second stop peg 23 is restricted by the edges of the first kidney-shaped hole 32 and the second kidney-shaped hole 33 to form a latching effect, such that the snap-in frame 2 will not be separated easily.

The pivot ring 21 is disposed at the center of the pivot hole 31, such that the center of the pivot ring 21 remains unchanged, and the change of the snap-in frame 2 also drives the evacuated movable plane 210 formed on the pivot ring 21 to change a position to an angle θ₂, and the position changed to the angle θ₂ is shown in FIG. 7, and its latch point P₂ will be moved to a 6 o'clock position, so that the radial plane 211 has a large surface on the pressed onto the internal circumferential surface of the pivot hole 31 to achieve the latching effect, and another latch point P₁ is formed at a lower circumferential surface of the second stop peg 23 and pressed on an arc shaped edge of the second kidney-shaped hole 33 (Now, the first stop peg 22 is also latched to the corresponding arc edge of the first kidney-shaped hole 32, and such position is also considered as a latch point). In a process of pulling the chain 4, a user drive the chain 4 to change the angular position of the snap-in frame 2, and the snap-in frame 2 synchronously drives the evacuated movable plane 210 and second stop peg 23 to make a change of the angular positions to produce two latch points P₁, P₂ (or latch points are formed additionally by the restriction of the first stop peg 22 and the first kidney-shaped hole 32), a straight line defined between the two latch points is substantially perpendicular to the linear angular position of pulling the chain 4, so that users can apply a force to drive the moving/braking wheel 20. With the limitation of the latch point P₁, P₂ in the process of pulling the chain 4, the snap-in frame 2 will not be separated from the cartridge 3 easily, so that users can fully apply a pulling force to the chain 4, and the moving/braking wheel 20 transmits the pulling force to the driven wheel 10 to satisfy the requirement of driving a curtain with a certain weight (wherein the users simply need to pull a side of the chain 4 to move or stop the moving/braking wheel 20, and the snap-in frame 2 will be deviated to an angle towards the pulling force, instead of pulling both sides of the chain 4).

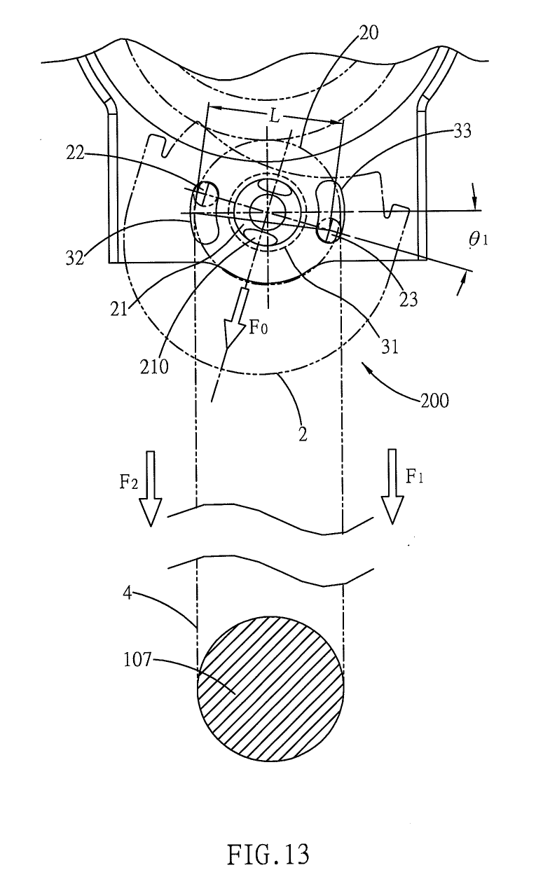

If a child is playing with the chain 4 and the chain 4 winds the child's limb 107 such as an arm or a neck by accident, the present invention provides a quick way of disconnecting the moving/braking unit 200 and the cartridge 3 by eliminating the binding force of the chain 4 exerted on the limb 107. With reference to FIGS. 13 to 17, FIG. 13 shows that if the snap-in frame 2 is maintained at an angle as shown in FIG. 12, and a struggling force of the limb 107 or a vertical force exerted on the lower close end of the chain 4 will pull both sides of the chain 4, wherein two pulling forces F₁, F₂ are formed, and the pulling force F₁ will press the second stop peg 23 downwardly against the lower circular end of the second kidney-shaped hole 33 through the moving/braking wheel 20, and another pulling force F₂ is exerted to a corresponding tangent position of the moving/braking wheel 20, and thus a moment L is produced the center of second stop peg 23 and a force F₂ is formed at a tangent position of the corresponding moving/braking wheel 20, and the moment L will increase a squeeze force F₀ at a position below the pivot ring 21. Now, the direction of the squeeze force F₀ is perpendicular to a spading direction of the evacuated movable plane 210, and then the squeeze force F₀ is acted onto the internal edge of the pivot hole 31 by the slope of the evacuated movable plane 210 to achieve the effect of separating the snap-in frame 2.

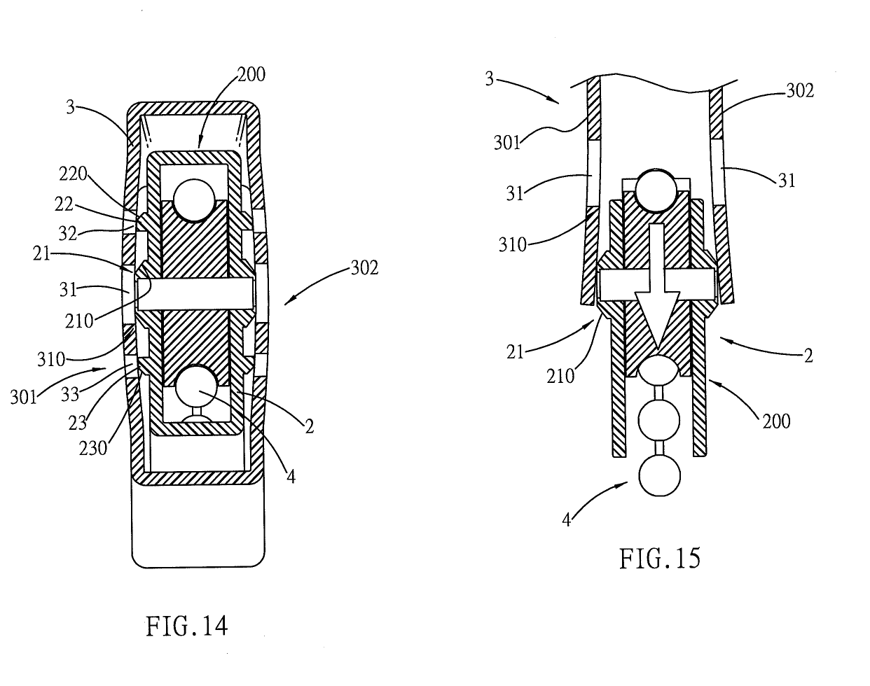

The squeeze condition is shown in FIG. 14. After the limb 107 is wound, the pivot ring 21 will be separated from the pivot hole 31 by pressing the evacuated movable plane 210 of the pivot ring 21 at the corresponding internal edge 310 of the pivot hole 31 to expand the span between the joint plate 301 and the joint plate 302 in the cartridge 3, and the increased span reserve the heights of the first stop peg 22 and the second stop peg 23, and the first stop peg 22 and the second stop peg 23 include a diagonal plane 220 and a diagonal plane 230 respectively, and the diagonal plane 220 and diagonal plane 230 are reserved space provided for avoiding any interference with the first kidney-shaped hole 32 and the second kidney-shaped hole 33 to successfully detach the snap-in frame 2, and surfaces of the diagonal planes 220, 230 can be planes or cambers.

With reference to FIG. 15 for a moving/braking unit 200 normally separated, the evacuated movable plane 210 of the pivot ring 21 installed on the snap-in frame 2 will squeeze the internal edge 310 of the pivot hole 31 to spread the joint plate 301 and joint plate 302 of the cartridge 3. FIG. 15 is a side view showing the relative positions of components during the separation process.

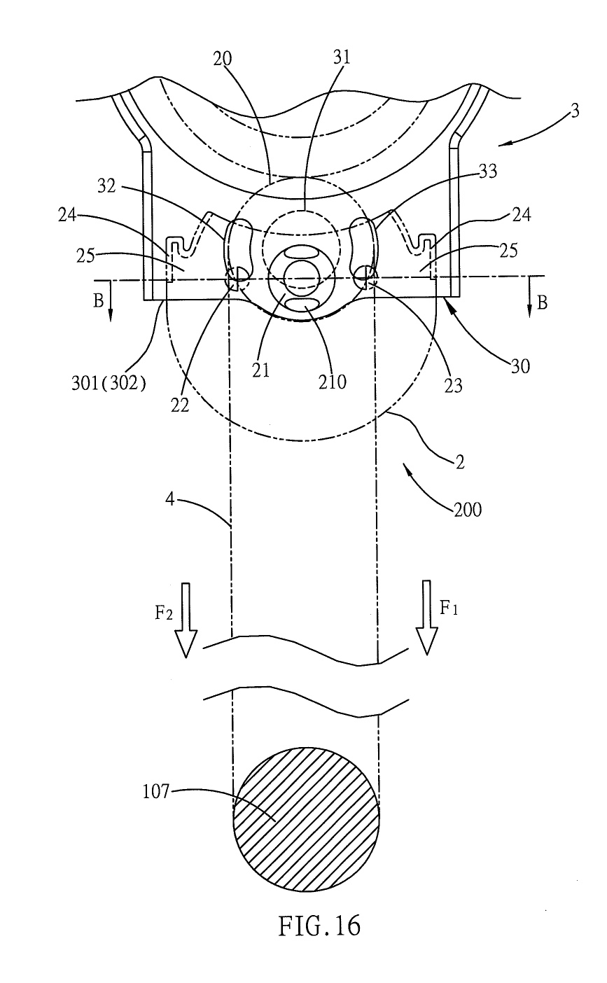

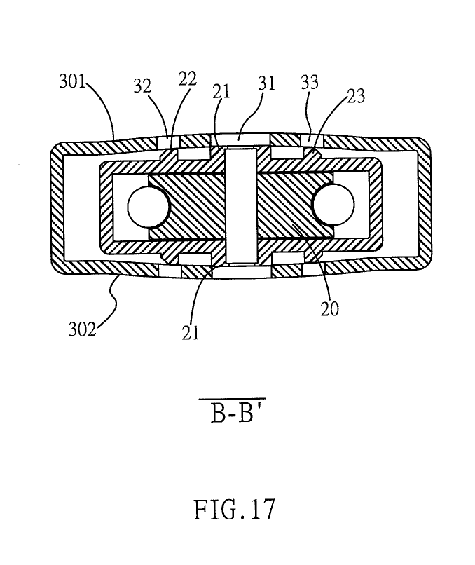

With reference to FIGS. 16 and 17 for the separation process, external edges of the aforementioned two pivot rings 21 will squeeze internal surfaces of the joint plate 301 and the joint plate 302 open to allow the span to fit the heights of first stop peg 22 and the second stop peg 23, such that the whole moving/braking unit 200 can be separated successfully, and the separation can be achieved efficiently as shown in FIGS. 12 and 13, such that the sum of the pulling forces F₁, F₂ is very small, and the small force is referred to a relatively small force for releasing the limb or the weight of the limb.

Another separation method of the present invention another does not require the aforementioned efficient separation, but simply applies the synchronous action of the limb 107 to both sides of the chain 4 to form the pulling forces F₁, F₂. If the forces provide a squeeze force F₀ equal to or greater than the squeeze force F₀ with the moment as shown in FIG. 13, then the evacuated movable plane 210 of the pivot ring 21 can be used directly to produce a squeeze force to squeeze the pivot hole 31 as shown in FIG. 17, such that the internal span between the universal driving shaft 12 and the joint plate 302 can be expanded to detach the whole moving/braking unit 200. If the chain 4 winds a child by accident, pulling forces F₁, F₂ produced by an action on both sides of the chain 4 can drive the evacuated movable plane 210 to produce a squeeze force F₀ to the pivot hole 31 to directly separate the moving/braking unit 200 from the cartridge 3, and this method is another safety protection to assist the aforementioned efficient separation method, such that if a child's limb is wound accidentally, the snap-in frame 2 can be detached to release the binding force of the chain 4.

The squeeze force F₀ does not exist at the time of normally pulling and adjusting the curtain to change the light shading area of the curtain, but both sides of the chain 4 are pulled by the pulling forces F₁, F₂ in an emergency situation in accordance with two separation methods as shown in FIGS. 13 and 16 respectively. Therefore, the present invention simply applies a force on a side of the chain 4 and allows user to apply forces fully to the moving/braking wheel 20 during a normal operation, and applies equal pulling force F₁, F₂ to both sides of the chain 4 simultaneously during an emergency situation such as a child's limb 107 being wound by the chain 4, so that a squeeze can be produced by the evacuated movable plane 210 of the pivot ring 21 to the pivot hole 31 of the cartridge 3 to separate the whole moving/braking unit 200.

After the moving/braking unit 200 is separated from the cartridge 3, the snap-in frame 2 being a small component may fall out, but the chain 4 passed through the through opening 25 of the snap-in frame 2 as shown in FIG. 7 will be stopped by the lateral connecting plates 24, and after the moving/braking unit 200 is separated from the cartridge 3, a movable connection between the snap-in frame 2 and the chain 4 can be achieved, so as to prevent the small snap-in frame 2 from being picked up by a child or eaten by mistake, or missing due to the pop-out action during the separation process.

The present invention provided a safety effect and allows users to fully apply a force to change the state of the shading surface of the curtain under the normal use, and also produces two pulling forces F₁, F₂ to the pulling string as shown in FIGS. 13 and 16 when a lower end of the pulling string is wound around a child's limb by accident, such that the whole moving/braking unit 200 can be detached to assure the safety effect. Compared with the conventional safety designs, the present invention can achieve the effects of fully applying a force in a normal operation and smoothly releasing the pulling string in an emergency condition to assure the safety effect. Obviously, the present invention improves over the prior art and complies with patent application requirements, and thus is duly filed for patent application.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A safety curtain structure, applied to a curtain module, and braked by a chain to change a light shading state of the curtain, and the system comprising:
a hub, having a hanging portion formed on an external surface of the hub, a driven wheel axially and pivotally installed in the hub, and a universal driving shaft coaxially and outwardly coupled to the driven wheel;
a cartridge, comprised of two joint plates disposed opposite to each other and elastically deformable in a plane, a axial center perpendicular to a plane of the universal driving shaft and disposed at a position combining a lower circular tangent point of the hub, a cartridge opening formed at a lower end of the cartridge and interconnected to a surface of the driven wheel, and two pivot holes being penetrating and formed on surfaces of two joint plates respectively, and disposed opposite to each other and parallel to a linear position of the axial center of the universal driving shaft, and a first kidney-shaped hole and a second kidney-shaped hole horizontally conjugated at the centers of the pivot holes respectively;
a moving and braking unit module, latched into the snap-in frame in an internal space of the cartridge, and flexibly coupled to a chain, wherein the snap-in frame includes two flat plates with planes opposite to each other and lateral edges coupled to connecting plates to form a square frame shape, and the planes of the two flat plates are parallel to the two joint plates and opposite to the centers of the pivot holes of the two joint plate, and the two flat plates are disposed at radius positions of the first kidney-shaped hole and the second kidney-shaped hole respectively, and have symmetrically protruded pivot rings, a first stop peg, a second stop peg, and the center of the pivot ring is provided for pivotally installing a moving and braking wheel, and an external oblique evacuated movable plane is formed at an external edge of the pivot ring and at least at a lower circular tangent position, and the bottom of the evacuated movable plane is proximate to the surface of the joint plate, and radial planes are reserved on both sides of the evacuated movable plane respectively;
wherein the safety curtain structure is assembled by making use of the flexible deformation of the two joint plates in a plane to change the span across internal surfaces of the two joint plates, pulling the evacuated movable plane disposed at the pivot ring of the snap-in frame pivot and both sides of the chain synchronously, and leveraging a fulcrum of the stop pegs to squeeze the evacuated movable plane radially to change the span, so as to retreat the snap-in frame out from the cartridge.

2. The safety curtain structure of claim 1, wherein the pivot ring includes a plurality of external oblique evacuated movable planes disposed at upper circular curve tangent positions respectively.

3. The safety curtain structure of claim 1, wherein the pivot ring of the snap-in frame is provided for pivotally installing the moving and braking wheel, and the moving and braking wheel includes a wheel axle, and the moving and braking wheel and the wheel axle are movably and frictionally coupled with the pivot ring.

4. The safety curtain structure of claim 1, wherein the first stop peg and second stop peg of the snap-in frame include external oblique diagonal planes facing in an outward direction opposite to the pivot holes.

5. The safety curtain structure of claim 4, wherein the diagonal plane is a camber.

6. The safety curtain structure of claim 1, wherein the evacuated movable plane is a three-dimensional camber.

7. A safety curtain braking method, provided for applying a force fully to drive a loop-shaped chain of a curtain module at a normal operation, and separating a coupled brake mechanism automatically at an emergency condition, and the method comprising the steps of:
preparing a moving and braking unit comprised of a snap-in frame, two parallel planes at the front and the back of the snap-in frame respectively, a pivot ring being penetrating and protruded separately, outwardly and perpendicularly from the centers of external surfaces of two parallel planes, and the axial centers of the two pivot rings being provided for pivotally installing a moving and braking wheel, and the moving and braking wheel being chained by a chain, and two symmetrical first stop peg and second stop peg disposed on both sides and at the center of the pivot ring, and an external oblique evacuated movable plane formed at the a lower circular tangent position of the pivot ring;
preparing a cartridge coupled to a lower circular tangent position of a hub, and having a cartridge opening formed at a lower end of the cartridge and interconnected to an external surface of a driven wheel installed inside the hub, and the interior of the cartridge being provided for the moving and braking unit to enter and exit, and two joint plates being disposed on two parallel planes of the cartridge with respect to front and rear ends of the snap-in frame opposite to the cartridge, and the two joint plates corresponding to the pivot rings of the snap-in frame, and a pivot hole being formed separately at the first stop peg and second stop peg, and symmetric first kidney-shaped hole and second kidney-shaped hole being conjugated with each other;
embedding the pivot ring of the moving and braking unit and the first stop peg and the second stop peg into the pivot hole and the first kidney-shaped hole and the second kidney-shaped hole of the cartridge, and engaging the moving and braking wheel of the snap-in frame with the driven wheel of the cartridge to pull a side of the chain downward, and engaging the moving and braking wheel with the driven wheel of the cartridge, and outwardly linking the driven wheel with the universal driving shaft to roll the curtain, such that the snap-in frame at an initial time is driven by a movable friction and the a side of the chain is pulled and deviated, and the angle of deviation is restricted by the first kidney-shaped hole and the second kidney-shaped hole of the cartridge specified by the first stop peg and the second stop peg of the snap-in frame, and the cartridge produces a latching effect to the snap-in frame to prevent the cartridge from separating from the snap-in frame and provide a full application of force to a side of the chain;
such that if both sides of the chain are pulled down synchronously, then either the first stop peg or the second stop peg becomes a fulcrum to provide an efficient way of applying forces to both sides of the chain to the evacuated movable plane of the pivot ring to allow the evacuated movable plane to expand the internal span of the cartridge so as to separate the snap-in frame from the cartridge easily.
